(19) United States
(12) Patent Application Publication
(10) Pub. No.: US 2015/0078457 A1
(43) Pub. Date: Mar. 19, 2015

(54) REPRESENTATION FORMAT SIGNALING IN MULTI-LAYER VIDEO CODING

(71) Applicant: QUALCOMM Incorporated, San Diego, CA (US)

(72) Inventors: Fnu Hendry, Poway, CA (US); Ye-Kui Wang, San Diego, CA (US)

(21) Appl. No.: 14/484,188

(22) Filed: Sep. 11, 2014

Related U.S. Application Data
(60) Provisional application No. 61/877,700, filed on Sep. 13, 2013.

(51) Int. Cl. H04N 19/44; H04N 19/30; H04N 19/46; H04N 19/70

(52) U.S. Cl. CPC H04N 19/00533; H04N 19/00884; H04N 19/00424; H04N 19/00545
USPC 375/240.25

(57) ABSTRACT

Techniques are described for signaling of representation format information in multi-layer bitstreams. Representation format information is signaled using representation format syntax structures included in a video parameter set (VPS) for a video sequence in a multi-layer bitstream. When syntax elements associated with the representation format syntax structures are not present in the VPS, a mapping of representation formats to layers in the multi-layer bitstream may be inferred. According to the techniques, in the absence of the syntax elements, a video decoder infers which of the representation format syntax structures is applied to which of the layers in the bitstream based on a number of the representation format syntax structures included in the VPS for the video sequence. By basing the inference on the number of representation format syntax structures for the video sequence, the inference may be accurate for the type of multi-layer video extension used in the multi-layer bitstream.

This application claims the benefit of U.S. Provisional Application No. 61/877,700, filed Sep. 13, 2013, the contents of which is hereby incorporated by reference in its entirety.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques for signaling of representation format information in multi-layer video bitstreams that use one or more of scalable video coding, multi-view video coding with or without depth, or other multi-layer video coding extensions to High Efficiency Video Coding (HEVC) and other video codecs. Representation format information for a video sequence includes one or more of spatial resolution, bit depth, color format information, or conformance window offset information. The representation format information is signaled using representation format syntax structures included in a video parameter set (VPS) for a video sequence in a multi-layer bitstream. If necessary, the representation format information may be updated in a sequence parameter set (SPS) of each layer in the multi-layer bitstream.

In some cases, a mapping of representation formats to layers in the multi-layer bitstream may be explicitly signaled in the VPS using syntax elements associated with the representation format syntax structures. In other cases, when the syntax elements associated with the representation format syntax structures are not present in the VPS, the representation format mapping may be inferred. According to the techniques of this disclosure, in the absence of the syntax elements associated with the representation format syntax structures, a video decoder infers which of the representation format syntax structures is applied to which of the layers in the bitstream based on a number of the representation format syntax structures included in the VPS for the video sequence. By basing the mapping inference on the number of representation format syntax structures for the video sequence, the inference may be accurate for the type of multi-layer video extension used in the multi-layer bitstream.

In one example, this disclosure is directed to a method of decoding video data, the method comprising receiving a VPS for a video sequence in a multi-layer bitstream, the VPS including one or more representation format syntax structures for the video sequence, determining whether syntax elements associated with the one or more representation format syntax structures for the video sequence are present in the VPS, and based on the syntax elements not being present in the VPS, inferring an index value of one of the one or more representation format syntax structures applied to each layer of the multi-layer bitstream based on a number of the one or more representation format syntax structures for the video sequence.

In another example, this disclosure is directed to a video decoding device comprising a memory configured to store video data, and one or more processors in communication with the memory. The one or more processors are configured to receive a VPS for a video sequence in a multi-layer bitstream, the VPS including one or more representation format syntax structures for the video sequence, determine whether syntax elements associated with the one or more representation format syntax structures for the video sequence are present in the VPS, and based on the syntax elements not being present in the VPS, infer an index value of one of the one or more representation format syntax structures applied to each layer of the multi-layer bitstream based on a number of the one or more representation format syntax structures for the video sequence.

In a further example, this disclosure is directed to a video decoding device comprising means for receiving a VPS for a video sequence in a multi-layer bitstream, the VPS including one or more representation format syntax structures for the video sequence, means for determining whether syntax elements associated with the one or more representation format syntax structures for the video sequence are present in the VPS, and based on the syntax elements not being present in the VPS, means for inferring an index value of one of the one or more representation format syntax structures applied to each layer of the multi-layer bitstream based on a number of the one or more representation format syntax structures for the video sequence.

In an additional example, this disclosure is directed to a computer-readable medium having stored thereon instructions for decoding video data that, when executed, cause one or more processors to receive a VPS for a video sequence in a multi-layer bitstream, the VPS including one or more representation format syntax structures for the video sequence, determine whether syntax elements associated with the one or more representation format syntax structures for the video sequence are present in the VPS, and based on the syntax elements not being present in the VPS, infer an index value of one of the one or more representation format syntax structures applied to each layer of the multi-layer bitstream based on a number of the one or more representation format syntax structures for the video sequence.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize representation format signaling techniques as described in this disclosure.

FIG. 2 is a block diagram illustrating an example of a video encoder that may implement techniques for indicating representation format information in multi-layer video coding.

FIG. 3 is a block diagram illustrating an example of a video decoder that may implement techniques for determining representation format information in multi-layer video coding.

FIG. 4 is a flowchart illustrating an example operation of indicating mapping of representation formats to layers in a multi-layer bitstream.

FIG. 5 is a flowchart illustrating an example operation of determining mapping of representation formats to layers in a multi-layer bitstream.

FIG. 6 is a flowchart illustrating an example operation of indicating a number of representation format syntax structures included in a VPS for a video sequence in a multi-layer bitstream.

FIG. 7 is a flowchart illustrating an example operation of determining a number of representation format syntax structures included in a VPS for a video sequence in a multi-layer bitstream.

### DETAILED DESCRIPTION

Techniques of this disclosure relate to signaling of representation format information in multi-layer video bitstreams that use one or more of scalable video coding, multi-view video coding with or without depth, or other multi-layer video coding extensions to High Efficiency Video Coding (HEVC) and other video codecs. Representation format information for a video sequence includes one or more of spatial resolution, bit depth, color format information, or conformance window offset information. The representation format information is signaled using representation format syntax structures included in a video parameter set (VPS) for a video sequence in a multi-layer bitstream. If necessary, the representation format information may be updated in a sequence parameter set (SPS) of each layer in the multi-layer bitstream.

In some cases, a mapping of representation formats to layers in the multi-layer bitstream may be explicitly signaled in the VPS using syntax elements associated with the representation format syntax structures. In other cases, when the syntax elements associated with the representation format syntax structures are not present in the VPS, the representation format mapping may be inferred. According to the techniques of this disclosure, in the absence of the syntax elements associated with the representation format syntax structures, a video decoder infers which of the representation format syntax structures is applied to which of the layers in the bitstream based on a number of the representation format syntax structures included in the VPS for the video sequence.

By basing the mapping inference on the number of representation format syntax structures for the video sequence, the inference may be accurate for the type of multi-layer video extension used in the multi-layer bitstream. In the case of the multi-view extension to HEVC, i.e., MV-HEVC, the representation format typically does not change from layer to layer in the multi-layer bitstream, such that the same representation format syntax structure is inferred as being applied to all of the layers in the multi-layer bitstream. In the case of the scalable extension to HEVC, i.e., SHVC, the representation format is typically different for each layer of the multi-layer bitstream, such that a different one of the representation format syntax structures is inferred as being applied to each of the layers in the multi-layer bitstream.

The representation format information signaled using the representation format syntax structures in the VPS is used to enable video coding devices to select which layers of the multi-layer bitstream to decode. For example, a video decoder may use one or more of the spatial resolution, bit depth, color format information, or conformance window offset information included in the representation format information applied to each of the layers of the multi-layer bitstream to determine which layers the video decoder is capable of decoding or which layers the video decoder should decode for presentation on a given display device. In some examples, the representation format information signaled in the VPS may be used to trigger output of all pictures stored in a decoded picture buffer (DPB) prior to application of a new representation format. In other examples, the representation format information applied to each of the layers in the multi-layer bitstream may be used to determine upsampling for interpolation of reference pictures for each of the layers in the multi-layer bitstream.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multi-view Video Coding (MVC) extensions.

The design of a new video coding standard, namely HEVC, has been finalized by the Joint Collaboration Team on Video Coding (JCT-VC) of ITU-T Video Coding Experts Group (VCEG) and ISO/IEC Motion Picture Experts Group (MPEG). A HEVC draft specification, referred to as HEVC Working Draft 10 (WD10), Bross et al., “High efficiency video coding (HEVC) text specification draft 10 (for FDIS & Last Call),” Joint Collaborative Team on Video Coding (JCT-VC) of ITU-T SG16 WP3 and ISO/IEC JTC1/SC29/WG11, 12th Meeting: Geneva, CH, 14-23 Jan. 2013, JCTVC-L1003v34, is available from http://phenix.int-evry.fr/jct/doc_end_user/documents/12_Geneva/wg11/JCTVC-L1003-v34.zip. The finalized standard document is published as ITU-T H.265, Series H: Audiovisual and Multimedia Systems, Infrastructure of audiovisual services—Coding of moving video, High efficiency video coding, Telecommunication Standardization Sector of International Telecommunication Union (ITU), April 2013.

The scalable extension to HEVC (SHVC) and the multi-view extension to HEVC (MV-HEVC) are being developed by the JCT-VC of ITU-T VCEG and ISO/IEC MPEG. A draft specification of SHVC, referred to as SHVC Working Draft 3 (WD3), Chen et al., “SHVC Draft 3,” Joint Collaborative Team on Video Coding (JCT-VC) of ITU-T SG16 WP3 and ISO/IEC JTC1/SC29/WG11, 14th Meeting: Vienna, AT, 25 Jul.-2 Aug. 2013, JCTVC-N1008v1, is available from http://phenix.int-evry.fr/jct/doc_end_user/documents/14_Vienna/wg11/JCTVC-N1008-v1.zip. A draft specification of MV-HEVC, referred to as MV-HEVC Working Draft 5 (WD5), Tech et al., “MV-HEVC Draft Text 5,” Joint Collaborative Team on 3D Video Coding Extension Development (JCT-3V) of ITU-T SG16 WP3 and ISO/IEC JTC1/SC29/WG11, 5th Meeting: Vienna, AT, 27 Jul.-2 Aug. 2013, JCT3V-E1004v6, is available from http://phenix.int-evry.fr/jct/doc_end_user/documents/5_Vienna/wg11/JCT3V-E1004-v6.zip.

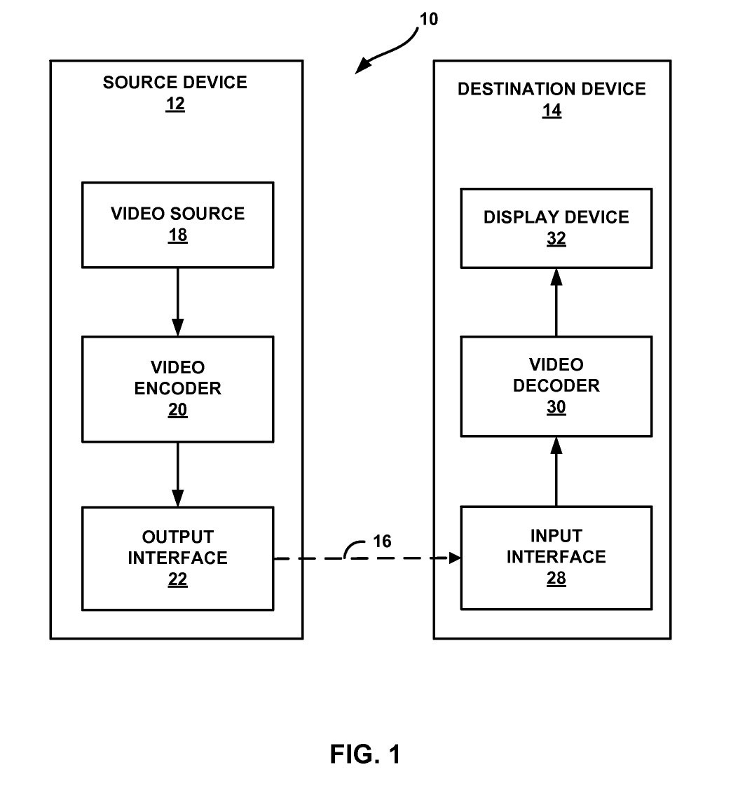

FIG. 1 is a block diagram illustrating an example video encoding and decoding system 10 that may utilize representation format signaling techniques as described in this disclosure. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming devices, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to a storage device. Similarly, encoded data may be accessed from the storage device by an input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, video decoder 30, and display device 32. In accordance with this disclosure, video encoder 20 of source device 12 may be configured to apply the techniques for processing video data in parallel. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for processing video data in parallel may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 28 of destination device 14 receives information from computer-readable medium 16. The information of computer-readable medium 16 may include syntax information defined by video encoder 20, which is also used by video decoder 30, that includes syntax elements that describe characteristics and/or processing of blocks and other coded units, e.g., groups of pictures (GOPs). Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

In some examples, video encoder 20 and video decoder 30 operate according to a video compression standard, such as ISO/IEC MPEG-4 Visual and ITU-T H.264 (also known as ISO/IEC MPEG-4 AVC), including its Scalable Video Coding (SVC) extension, Multi-view Video Coding (MVC) extension, and MVC-based three-dimensional video (3DV) extension. In some instances, any legal bitstream conforming to MVC-based 3DV always contains a sub-bitstream that is compliant to a MVC profile, e.g., stereo high profile. Furthermore, there is an ongoing effort to generate a 3DV coding extension to H.264/AVC, namely AVC-based 3DV. In other examples, video encoder 20 and video decoder 30 may operate according to ITU-T H.261, ISO/IEC MPEG-1 Visual, ITU-T H.262 or ISO/IEC MPEG-2 Visual, ITU-T H.263, ISO/IEC MPEG-4 Visual, and ITU-T H.264, ISO/IEC MPEG-4 AVC. In the example of FIG. 1, video encoder 20 and video decoder 30 may operate according to HEVC WD10, SHVC WD3, or MV-HEVC WD5, referenced above.

In HEVC and other video coding standards, a video sequence typically includes a series of pictures. Pictures may also be referred to as “frames.” A picture may include three sample arrays, denoted S_{L}, S_{Cb}, and S_{Cr}. S_{L} is a two-dimensional array (i.e., a block) of luma samples. S_{Cb} is a two-dimensional array of Cb chrominance samples. S_{Cr} is a two-dimensional array of Cr chrominance samples. Chrominance samples may also be referred to herein as “chroma” samples. In other instances, a picture may be monochrome and may only include an array of luma samples.

Video encoder 20 may generate a set of coding tree units (CTUs). Each of the CTUs may comprise a coding tree block of luma samples, two corresponding coding tree blocks of chroma samples, and syntax structures used to code the samples of the coding tree blocks. In a monochrome picture or a picture that has three separate color planes, a CTU may comprise a single coding tree block and syntax structures used to code the samples of the coding tree block. A coding tree block may be an N×N block of samples. A CTU may also be referred to as a “tree block” or a “largest coding unit” (LCU). The CTUs of HEVC may be broadly analogous to the macroblocks of other video coding standards, such as H.264/AVC. However, a CTU is not necessarily limited to a particular size and may include one or more coding units (CUs). A slice may include an integer number of CTUs ordered consecutively in the raster scan.

This disclosure may use the term “video unit” or “video block” to refer to one or more blocks of samples and syntax structures used to code samples of the one or more blocks of samples. Example types of video units may include CTUs, CUs, PUs, transform units (TUs), macroblocks, macroblock partitions, and so on.

To generate a coded CTU, video encoder 20 may recursively perform quad-tree partitioning on the coding tree blocks of a CTU to divide the coding tree blocks into coding blocks, hence the name “coding tree units.” A coding block is an N×N block of samples. A CU may comprise a coding block of luma samples and two corresponding coding blocks of chroma samples of a picture that has a luma sample array, a Cb sample array and a Cr sample array, and syntax structures used to code the samples of the coding blocks. In a monochrome picture or a picture that have three separate color planes, a CU may comprise a single coding block and syntax structures used to code the samples of the coding block.

Video encoder 20 may partition a coding block of a CU into one or more prediction blocks. A prediction block may be a rectangular (i.e., square or non-square) block of samples on which the same prediction is applied. A prediction unit (PU) of a CU may comprise a prediction block of luma samples, two corresponding prediction blocks of chroma samples of a picture, and syntax structures used to predict the prediction block samples. In a monochrome picture or a picture that have three separate color planes, a PU may comprise a single prediction block and syntax structures used to predict the prediction block samples. Video encoder 20 may generate predictive luma, Cb and Cr blocks for luma, Cb and Cr prediction blocks of each PU of the CU.

Video encoder 20 may use intra prediction or inter prediction to generate the predictive blocks for a PU. If video encoder 20 uses intra prediction to generate the predictive blocks of a PU, video encoder 20 may generate the predictive blocks of the PU based on decoded samples of the picture associated with the PU.

If video encoder 20 uses inter prediction to generate the predictive blocks of a PU, video encoder 20 may generate the predictive blocks of the PU based on decoded samples of one or more pictures other than the picture associated with the PU. Inter prediction may be uni-directional inter prediction (i.e., uni-prediction) or bi-directional inter prediction (i.e., bi-prediction). To perform uni-prediction or bi-prediction, video encoder 20 may generate a first reference picture list (RefPicList0) and a second reference picture list (RefPicList1) for a current slice. Each of the reference picture lists may include one or more reference pictures. When using uni-prediction, video encoder 20 may search the reference pictures in either or both RefPicList0 and RefPicList1 to determine a reference location within a reference picture. Furthermore, when using uni-prediction, video encoder 20 may generate, based at least in part on samples corresponding to the reference location, the predictive sample blocks for the PU. Moreover, when using uni-prediction, video encoder 20 may generate a single motion vector that indicates a spatial displacement between a prediction block of the PU and the reference location. To indicate the spatial displacement between a prediction block of the PU and the reference location, a motion vector may include a horizontal component specifying a horizontal displacement between the prediction block of the PU and the reference location and may include a vertical component specifying a vertical displacement between the prediction block of the PU and the reference location.

When using bi-prediction to encode a PU, video encoder 20 may determine a first reference location in a reference picture in RefPicList0 and a second reference location in a reference picture in RefPicList1. Video encoder 20 may then generate, based at least in part on samples corresponding to the first and second reference locations, the predictive blocks for the PU. Moreover, when using bi-prediction to encode the PU, video encoder 20 may generate a first motion indicating a spatial displacement between a sample block of the PU and the first reference location and a second motion indicating a spatial displacement between the prediction block of the PU and the second reference location.

After video encoder 20 generates predictive luma, Cb, and Cr blocks for one or more PUs of a CU, video encoder 20 may generate a luma residual block for the CU. Each sample in the CU's luma residual block indicates a difference between a luma sample in one of the CU's predictive luma blocks and a corresponding sample in the CU's original luma coding block. In addition, video encoder 20 may generate a Cb residual block for the CU. Each sample in the CU's Cb residual block may indicate a difference between a Cb sample in one of the CU's predictive Cb blocks and a corresponding sample in the CU's original Cb coding block. Video encoder 20 may also generate a Cr residual block for the CU. Each sample in the CU's Cr residual block may indicate a difference between a Cr sample in one of the CU's predictive Cr blocks and a corresponding sample in the CU's original Cr coding block.

Furthermore, video encoder 20 may use quad-tree partitioning to decompose the luma, Cb and, Cr residual blocks of a CU into one or more luma, Cb, and Cr transform blocks. A transform block may be a rectangular block of samples on which the same transform is applied. A transform unit (TU) of a CU may comprise a transform block of luma samples, two corresponding transform blocks of chroma samples, and syntax structures used to transform the transform block samples. In a monochrome picture or a picture that has three separate color planes, a TU may comprise a single transform block and syntax structures used to transform the transform block samples. Thus, each TU of a CU may be associated with a luma transform block, a Cb transform block, and a Cr transform block. The luma transform block associated with the TU may be a sub-block of the CU's luma residual block. The Cb transform block may be a sub-block of the CU's Cb residual block. The Cr transform block may be a sub-block of the CU's Cr residual block.

Video encoder 20 may apply one or more transforms to a luma transform block of a TU to generate a luma coefficient block for the TU. A coefficient block may be a two-dimensional array of transform coefficients. A transform coefficient may be a scalar quantity. Video encoder 20 may apply one or more transforms to a Cb transform block of a TU to generate a Cb coefficient block for the TU. Video encoder 20 may apply one or more transforms to a Cr transform block of a TU to generate a Cr coefficient block for the TU.

After generating a coefficient block (e.g., a luma coefficient block, a Cb coefficient block or a Cr coefficient block), video encoder 20 may quantize the coefficient block. Quantization generally refers to a process in which transform coefficients are quantized to possibly reduce the amount of data used to represent the transform coefficients, providing further compression. Furthermore, video encoder 20 may inverse quantize transform coefficients and apply an inverse transform to the transform coefficients in order to reconstruct transform blocks of TUs of CUs of a picture. Video encoder 20 may use the reconstructed transform blocks of TUs of a CU and the predictive blocks of PUs of the CU to reconstruct coding blocks of the CU. By reconstructing the coding blocks of each CU of a picture, video encoder 20 may reconstruct the picture. Video encoder 20 may store reconstructed pictures in a decoded picture buffer (DPB). Video encoder 20 may use reconstructed pictures in the DPB for inter prediction and intra prediction.

After video encoder 20 quantizes a coefficient block, video encoder 20 may entropy encode syntax elements that indicate the quantized transform coefficients. For example, video encoder 20 may perform Context-Adaptive Binary Arithmetic Coding (CABAC) on the syntax elements indicating the quantized transform coefficients. Video encoder 20 may output the entropy-encoded syntax elements in a bitstream.

Video encoder 20 may output a bitstream that includes a sequence of bits that forms a representation of coded pictures and associated data. The bitstream may comprise a sequence of network abstraction layer (NAL) units. Each of the NAL units includes a NAL unit header and encapsulates a raw byte sequence payload (RBSP). The NAL unit header may include a syntax element that indicates a NAL unit type code. The NAL unit type code specified by the NAL unit header of a NAL unit indicates the type of the NAL unit. A RBSP may be a syntax structure containing an integer number of bytes that is encapsulated within a NAL unit. In some instances, an RBSP includes zero bits.

Different types of NAL units may encapsulate different types of RBSPs. For example, a first type of NAL unit may encapsulate a RBSP for a picture parameter set (PPS), a second type of NAL unit may encapsulate a RBSP for a coded slice, a third type of NAL unit may encapsulate a RBSP for Supplemental Enhancement Information (SEI), and so on. A PPS is a syntax structure that may contain syntax elements that apply to zero or more entire coded pictures. NAL units that encapsulate RBSPs for video coding data (as opposed to RBSPs for parameter sets and SEI messages) may be referred to as video coding layer (VCL) NAL units. A NAL unit that encapsulates a coded slice may be referred to herein as a coded slice NAL unit. A RBSP for a coded slice may include a slice header and slice data.

Video decoder 30 may receive a bitstream. In addition, video decoder 30 may parse the bitstream to decode syntax elements from the bitstream. Video decoder 30 may reconstruct the pictures of the video data based at least in part on the syntax elements decoded from the bitstream. The process to reconstruct the video data may be generally reciprocal to the process performed by video encoder 20. For instance, video decoder 30 may use motion vectors of PUs to determine predictive blocks for the PUs of a current CU. Video decoder 30 may use a motion vector or motion vectors of PUs to generate predictive blocks for the PUs.

In addition, video decoder 30 may inverse quantize coefficient blocks associated with TUs of the current CU. Video decoder 30 may perform inverse transforms on the coefficient blocks to reconstruct transform blocks associated with the TUs of the current CU. Video decoder 30 may reconstruct the coding blocks of the current CU by adding the samples of the predictive sample blocks for PUs of the current CU to corresponding samples of the transform blocks of the TUs of the current CU. By reconstructing the coding blocks for each CU of a picture, video decoder 30 may reconstruct the picture. Video decoder 30 may store decoded pictures in a decoded picture buffer for output and/or for use in decoding other pictures.

In MV-HEVC and SHVC, a video encoder may generate a multi-layer bitstream that comprises a series of network abstraction layer (NAL) units. Different NAL units of the bitstream may be associated with different layers of the bitstream. A layer may be defined as a set of video coding layer (VCL) NAL units and associated non-VCL NAL units that have the same layer identifier. A layer may be equivalent to a view in multi-view video coding. In multi-view video coding, a layer can contain all view components of the same layer with different time instances. Each view component may be a coded picture of the video scene belonging to a specific view at a specific time instance. In 3D video coding, a layer may contain either all coded depth pictures of a specific view or coded texture pictures of a specific view. Similarly, in the context of scalable video coding, a layer typically corresponds to coded pictures having video characteristics different from coded pictures in other layers. Such video characteristics typically include spatial resolution and quality level (Signal-to-Noise Ratio). In HEVC and its extensions, temporal scalability may be achieved within one layer by defining a group of pictures with a particular temporal level as a sub-layer.

For each respective layer of the bitstream, data in a lower layer may be decoded without reference to data in any higher layer. In scalable video coding, for example, data in a base layer may be decoded without reference to data in an enhancement layer. NAL units only encapsulate data of a single layer. In SHVC, a view may be referred to as a “base layer” if a video decoder can decode pictures in the view without reference to data of any other layer. The base layer may conform to the HEVC base specification. Thus, NAL units encapsulating data of the highest remaining layer of the bitstream may be removed from the bitstream without affecting the decodability of data in the remaining layers of the bitstream. In MV-HEVC, higher layers may include additional view components. In SHVC, higher layers may include signal to noise ratio (SNR) enhancement data, spatial enhancement data, and/or temporal enhancement data.

Techniques of this disclosure relate to signaling of representation format information in multi-layer bitstreams that use one or more of scalable video coding, multi-view video coding with or without depth, or other multi-layer video coding extensions to HEVC and other video codecs. Examples are described below with respect to the SHVC and MV-HEVC extensions to HEVC. Representation format information for a video sequence includes one or more of spatial resolution, bit depth, color format information, or conformance window offset information.

The representation format information is signaled using representation format syntax structures included in a video parameter set (VPS) for a video sequence in a multi-layer bitstream. If necessary, the representation format information may be updated in a sequence parameter set (SPS) of each layer in the multi-layer bitstream. The VPS is a sequence syntax structure including syntax elements that apply to zero or more entire coded video sequences as determined by the SPS. The SPS is a sequence syntax structure including syntax elements that apply to zero or more entire coded video sequences as determined by a picture parameter set (PPS). The PPS is a picture syntax structure including syntax elements that apply to zero or more entire coded pictures as determined by each slice header.

The representation format information signaled using the representation format syntax structures in the VPS is used to enable video coding devices to select which layers of the multi-layer bitstream to decode. For example, video decoder 30 may use one or more of the spatial resolution, bit depth, color format information, or conformance window offset information included in the representation format information applied to each of the layers of the multi-layer bitstream to determine which layers video decoder 30 is capable of decoding or which layers video decoder 30 should decode for presentation on display device 32. In some examples, the representation format information signaled in the VPS may be used to trigger output of all pictures stored in a decoded picture buffer (DPB) prior to application of a new representation format. In other examples, the representation format information applied to each of the layers in the multi-layer bitstream may be used to determine upsampling for interpolation of reference pictures for each of the layers in the multi-layer bitstream.

In some cases, a mapping of the representation formats to the layers in the multi-layer bitstream may be explicitly signaled in the VPS using syntax elements associated with the representation format syntax structures. In other cases, when the syntax elements associated with the representation format syntax structures are not present in the VPS, the representation format mapping may be inferred. Conventionally, if syntax elements are not present in the VPS, it is inferred that a representation format syntax structure with an index value equal to zero is applied to all of the layers in the bitstream. This inference may be accurate in the case where MV-HEVC is the multi-layer video extension used in the bitstream, but may not be accurate in the case where SHVC is the multi-layer video extension used in the bitstream. In the case of MV-HEVC, the representation format typically does not change from layer to layer in the multi-layer bitstream. On the other hand, in the case of SHVC, the representation format is typically different for each layer of the multi-layer bitstream.

The syntax table and semantics of syntax elements related to the representation format information signaling in the VPS for both SHVC WD3 and MV-HEVC WD5 is as follows in Table 1:

TABLE 1

| | Descriptor |
|---|---|
| vps_extension( ) { | |
| ... | |
| rep_format_idx_present_flag | u(1) |
| if( rep_format_idx_present_flag ) | |
| vps_num_rep_formats_minus1 | u(4) |
| for( i = 0; i <= vps_num_rep_formats_minus1; i++ ) | |
| rep_format( ) | |
| if( rep_format_idx_present_flag ) | |
| for( i = 1; i <= vps_max_layers_minus1; i++ ) | |
| if( vps_num_rep_formats_minus1 > 0 ) | |
| vps_rep_format_idx[ i ] | u(4) |
| ... | |
| } | |

The rep format_idx_present_flag equal to 1 specifies that the syntax elements vps_num_rep_formats_minus1 and vps_rep format_idx[i] are present. The rep_format_idx_present_flag equal to 0 specifies that the syntax elements vps_num_rep_formats_minus1 and vps_rep_format_idx[i] are not present.

The value of vps_num_rep_formats_minus1 plus 1 specifies the number of the following rep_format( ) syntax structures in the VPS. When not present, the value of vps_num_rep_formats_minus1 is inferred to be equal to vps_max_layers_minus1.

The value of vps_rep_format_idx[i] specifies the index, into the list of rep_format( ) syntax structures in the VPS, of the rep_format( ) syntax structure that applies to the layer with nuh_layer_id equal to layer_id_in_nuh[i]. When not present, the value of vps_rep_format_idx[i] is inferred to be equal to 0. The value of vps_rep_format_idx[i] shall be in the range of 0 to vps_num_rep_formats_minus1, inclusive.

The rep_format( ) syntax structure and semantics of related syntax elements is as follows in Table 2:

TABLE 2

| | Descriptor |
|---|---|
| rep_format( ) { | |
| chroma_format_vps_idc | u(2) |
| if( chroma_format_vps_idc = = 3 ) | |
| separate_colour_plane_vps_flag | u(1) |
| pic_width_vps_in_luma_samples | u(16) |
| pic_height_vps_in_luma_samples | u(16) |
| bit_depth_vps_luma_minus8 | u(4) |
| bit_depth_vps_chroma_minus8 | u(4) |
| } | |

The values of chroma_format_vps_idc, separate_colour_plane vps_flag, pic_width_vps_in_luma_samples, pic_height_vps_in_luma_samples, bit_depth_vps_luma_minus8, and bit_depth_vps_chroma_minus8 are used for inference of the values of the SPS syntax elements chroma_format_idc, separate_colour_plane_flag, pic_width_in_luma_samples, pic_height_in_luma_samples, bit_depth_luma_minus8, and bit_depth_chroma_minus8, respectively, for each SPS that refers to the VPS. For each of these VPS syntax elements, all constraints, if any, that apply to the value of the corresponding SPS syntax element also apply to the VPS syntax element.

The above-described design of the VPS syntax table and semantics of the related syntax elements for SHVC WD3 and MV-HEVC WD5 has a few issues with respect to inference rules for inference of certain conditions by a video decoder when certain of the syntax elements are not present in the VPS signaled by a video encoder and received by the video decoder. A first issue is based on the design of the portion of the VPS syntax table related to the mapping of representation formats to the layers of the multi-layer bitstream. In Table 1 above, the condition check “if(vps_num_rep_formats_minus1>0),” which is inside the loop “for(i=1; i<=vps_max_layers_minus1; i++),” is not efficient. This design requires performance of the condition check by the video decoder, i.e., whether a number of representation format syntax structures for the video sequence is greater than one, as many times as the total number of layers in the bitstream, indicated by the syntax element vps_max_layers_minus1.

A second issue is based on the inference rule for the number of representation format syntax structures for the video sequence, indicated by the syntax element vps_num_rep_formats_minus1, when the syntax elements associated with the representation format syntax structures are not present in the VPS, indicated by rep_format_idx_present_flag equal to 0. When rep_format_idx_present_flag is equal to 0, vps_num_rep_formats_minus1 is not explicitly signaled in the VPS by the video encoder and the number of representation format syntax structures for the video sequence is inferred by the video decoder to be equal to the total number of layers in the multi-layer bitstream. This inference is accurate for SHVC because, in some typical scenarios for the scalable extension, the representation format of each layer is different. For MV-HEVC, however, it would be more accurate for the video decoder to infer that the number of representation format syntax structures is equal because, in some typical scenarios for the multi-view extension, the representation format does not change from layer to layer.

A third issue is based on whether the syntax elements associated with the representation format syntax structures are present in the VPS, indicated by rep_format_idx_present_flag, when both the scalable extension and the multi-view extension are used in the multi-layer bitstream. Conventionally, the value of rep_format_idx_present_flag is flexible such that the video encoder can freely decide its value, i.e., whether or not to explicitly signal the syntax elements associated with the representation format syntax structures. When the value of rep_format_idx_present_flag is equal to 0 such that the syntax elements are not present in the VPS, the number of the representation format syntax structures for the video sequence, indicated by vps_num_rep_formats_minus1, is inferred by the video decoder. This inference by the video decoder is acceptable when only one type of extension is used in the multi-layer bitstream (e.g., either the SHVC extension or the MV-HEVC extension). When both extensions exist in the multi-layer bitstream, however, the value of vps_num_rep_formats_minus1 should not be inferred by the video decoder.

A fourth issue is based on the inference rule for the mapping of representation formats to the layers of the multi-layer bitstream, indicated by vps_rep_format_idx[i], where i is in the range of 1 to the total number of layers minus one, and vps_rep_format_idx[i] is in the range of 0 to the number of representation format syntax structures minus 1. Conventionally, when rep_format_idx_present_flag is equal to 0 such that the syntax elements associated with the representation format syntax structures are not present in the VPS, the index value of the representation format syntax structures applied to each of the layers in the multi-layer bitstream, indicated by vps_rep_format_idx[i], is inferred by the video decoder to be equal to 0. This inference by the video decoder is not correct when rep_format_idx_present_flag is equal to 0 and vps_num_rep_formats_minus1 is greater than 0, because, in that case, more than one representation format syntax structure is included in the VPS but only the first one having the index value equal to 0 is used while the remaining representation formats are never used.

To overcome the above issues or shortcomings, techniques are proposed, which can be applied individually or in combination. According to the techniques of this disclosure, in the absence of the syntax elements associated with the representation format syntax structures, a video decoder infers which of the representation format syntax structures is applied to which of the layers in the multi-layer bitstream based on a number of the representation format syntax structures included in the VPS for the video sequence.

By basing the mapping inference on the number of representation format syntax structures for the video sequence, the inference may be accurate for the type of multi-layer video extension used in the multi-layer bitstream. In the case of the multi-view extension to HEVC, i.e., MV-HEVC, the representation format typically does not change from layer to layer in the multi-layer bitstream, such that the same representation format syntax structure is inferred by the video decoder as being applied to all of the layers in the multi-layer bitstream. In the case of the scalable extension to HEVC, i.e., SHVC, the representation format is typically different for each layer of the multi-layer bitstream, such that a different one of the representation format syntax structures is inferred by the video decoder as being applied to each of the layers in the multi-layer bitstream.

To address the first issue described above, it is proposed to have the following alternative solutions to the design of the VPS syntax table related to the representation format information signaling shown in Table 1 above.

In a first example alternative, in the portion of the VPS syntax table related to the representation format information signaling, it is proposed to move the condition check “if(vps_num_rep_formats_minus1>0)” from within the loop “for(i=1; i<=vps_max_layers_minus1; i++)” to outside the loop. In this way, the condition check of whether a number of representation format syntax structures for the video sequence is greater than one will be performed by the video decoder as part of the condition to enter the loop “for(i=1; i<=vps_max_layers_minus1; i++)” to determine the mapping of the representation format syntax formats to the layers of the multi-layer bitstream. This first alternative design of the portion of the VPS syntax table related to the representation format information signaling is shown in Table 3 below.

As a second example alternative, in the portion of the VPS syntax table related to the representation format information signaling, it is proposed to remove the condition check “if(vps_num_rep_formats_minus1>0)” from within the loop “for(i=1; i<=vps_max_layers_minus1; i++),” and modify the inference rules for vps_rep_format_idx[i] when not present in the VPS. This second alternative design of the portion of the VPS syntax table related to the representation format information signaling is shown in Table 4 below. This second alternative also may solve the fourth issue described above.

According to the second alternative design, the index value of a representation format syntax structure applied to each layer of the multi-layer bitstream, indicated by vps_rep_format_idx[i], is inferred by the video decoder based on a number of the representation format syntax structures for the video sequence, indicated by vps_num_rep_formats_minus1, as follows.

When rep_format_idx_present_flag is equal to 0 and vps_num_rep_formats_minus1 is equal to vps_max_layers_minus1, the value of vps_rep_format_idx[i] is inferred by the video decoder to be equal to i, for i ranges from 0 to vps_max_layers_minus1, inclusive. In this case, when the number of representation format syntax structures is equal to the number of layers, a one-to-one mapping is inferred by the video decoder. In this one-to-one mapping, each of the representation format syntax structures is applied to a different one of the layers.

When rep_format_idx_present_flag is equal to 0 and vps_num_rep_formats_minus1 is equal to 0, the value of vps_rep_format_idx[i] is inferred by the video decoder to be equal to 0, for i ranges from 0 to vps_max_layers_minus1, inclusive. In this case, when a single representation format syntax structure is signaled for the video sequence, it is inferred by the video decoder that the single representation formation syntax structure is applied to all of the layers.

When rep_format_idx_present_flag is equal to 1 and i is equal to 0, the value of vps_rep_format_idx[0] is inferred by the video decoder to be equal to 0, where i equal to 0 indicates a first layer, i.e., a base layer, of the bitstream. In this case, even when the syntax elements are present in the VPS, the representation format applied to the base layer in the bitstream may not be explicitly indicated in the VPS by the video encoder. It may instead be inferred by the video decoder that a first representation format syntax structure having an index value equal to zero is applied to the base layer in the bitstream. A base layer included in the bitstream may conform to the HEVC standard. In other examples, a base layer external to the bitstream may conform to a different video coding standard and may be assigned a representation format that may be signaled by the video encoder or inferred by the video decoder.

To address the second issue described above, it is proposed to modify the inference rules for the number of representation format syntax structures for the video sequence, indicated by vps_num_rep_formats_minus1, when the syntax element is not present in the VPS. This solution may also solve the fourth issue described above. According to this solution, the value of vps_num_rep_formats_minus1, when not present in the VPS, may be inferred by the video decoder as follows. This solution is described with respect to the semantics of the syntax elements shown in Table 3 and Table 4 below.

When the scalable extension is used in the multi-layer bitstream and the multi-view extension is not used in the multi-layer bitstream, the value of vps_num_rep_formats_minus1 is inferred by the video decoder to be equal to vps_max_layers_minus1. In the case of SHVC, the representation format is typically different for each layer of the multi-layer bitstream. It is accurate, therefore, for the video decoder to infer that the SHVC bitstream includes a number of the representation format syntax structures equal to the total number of layers for the video sequence, such that a different one of the representation format syntax structures is applied to each of the layers in the multi-layer bitstream.

When the scalable extension is not used in the multi-layer bitstream and the multi-view extension is used in the multi-layer bitstream, the value of vps_num_rep_formats_minus1 is inferred by the video decoder to be equal to 0. In the case of MV-HEVC, the representation format typically does not change from layer to layer in the multi-layer bitstream. It is accurate, therefore, for the video decoder to infer that the MV-HEVC bitstream includes a single representation format syntax structure for the video sequence, such that the single representation format syntax structure is applied to all of the layers in the multi-layer bitstream.

To address the third issue described above, it is proposed to add a constraint in the semantics of the syntax elements in the VPS syntax table related to the representation format information signaling such that when the multi-layer bitstream uses both the scalable extension and the multi-view extension, the rep_format_idx_present_flag shall be equal to 1, meaning that the number of representation format syntax structures for the video sequence, indicated by vps_num_rep_formats_minus1, is not inferred by the video decoder but is explicitly signaled by the video encoder in the VPS. In this case, when both the MV-HEVC and the SHVC extensions are used in the bitstream, it may be difficult or impossible for the video decoder to infer an accurate number of representation format syntax structures for both types of extensions. This solution is described with respect to the semantics of the syntax elements shown in Table 3 and Table 4 below.

Some of the above-described techniques are further described in more detail below. The existing VPS syntax table and semantics of syntax elements related to the representation format information signaling in the VPS for the SHVC and MV-HEVC extensions to the HEVC specification are used as a base with newly added text indicated with italicized text and removed text indicted by single brackets and the term “REMOVED.”

In a first example, the techniques for signaling of representation format information may be implemented by modifying the VPS syntax table and associated semantics as follows in Table 3:

TABLE 3

| | Descriptor |
|---|---|
| vps_extension( ) { | |
| ... | |
| rep_format_idx_present_flag | u(1) |
| if( rep_format_idx_present_flag ) | |
| vps_num_rep_formats_minus1 | u(4) |
| for( i = 0; i <= vps_num_rep_formats_minus1; i++ ) | |
| rep_format( ) | |
| if( rep_format_idx_present_flag && | |
| vps_num_rep_formats_minus1 > 0 ) | |
| for( i = 1; i <= vps_max_layers_minus1; i++ ) | |
| [REMOVED: if( vps_num_rep_formats_minus1 > 0 )] | |
| vps_rep_format_idx[ i ] | u(4) |
| ... | |
| } | |

The rep_format_idx_present_flag equal to 1 specifies that the syntax elements vps_num_rep_formats_minus 1 and vps_rep_format_idx[i] are present. The rep_format_idx_present_flag equal to 0 specifies that the syntax elements vps_num_rep_formats_minus 1 and vps_rep_format_idx[i] are not present.

It is a requirement of bitstream conformance that, when both scalability_mask[1] and scalability_mask[2] are equal to 1, the value of rep_format_idx_present_flag shall be equal to 1. [Note: The scalability_mask[1] equal to 1 indicates that the multi-view extension is used in the bitstream. The scalability_mask[2] equal to 1 indicates that the scalable extension is used in the bitstream.]

The value of vps_num_rep_formats_minus1 plus 1 specifies the number of the following rep_format( ) syntax structures in the VPS. [REMOVED: When not present, the value of vps_num_rep_formats_minus1 is inferred to be equal to vps_max_layers_minus1.]

When not present, the value of vps_num_rep_formats_minus1 is inferred as follow:

When scalability_mask[1] is equal to 1 and scalability_mask[2] is equal to 0, vps_num_rep_formats_minus1 is inferred to be equal to 0.

Otherwise, when scalability_mask[1] is equal to 0 and scalability_mask[2] is equal to 1, vps_num_rep_formats_minus1 is inferred to be equal to vps_max_layers_minus1.

The value of vps_rep_format_idx[i] specifies the index, into the list of rep_format( ) syntax structures in the VPS, of the rep_format( ) syntax structure that applies to the layer with nuh_layer_id equal to layer_id_in_nuh[i]. [REMOVED: When not present, the value of vps_rep_format_idx[i] is inferred to be equal to 0.] The value of vps_rep_format_idx[i] shall be in the range of 0 to vps_num_rep_formats_minus1, inclusive.

When not present, the value of vps_rep_format_idx[i] is inferred as follows:

If rep_format_idx_present_flag is equal to 0 and vps_num_rep_formats_minus1 is equal to vps_max_layers_minus1, the value of vps_rep_format_idx[i] is inferred to be equal to i, for each value of i in the range of 0 to vps_max_layers_minus1, inclusive.

Otherwise, if rep_format_idx_present_flag is equal to 0 and vps_num_rep_formats_minus1 is equal to 0, the value of vps_rep_format_idx[i] is inferred to be equal to 0, for each value of i in the range of 0 to vps_max_layers_minus1, inclusive.

Otherwise (rep_format_idx_present_flag is equal to 1 and i is equal to 0), the value of vps_rep_format_idx[0] is inferred to be equal to 0.

In a second example, the techniques for signaling of representation format information may be implemented by modifying the VPS syntax table as follows in Table 4:

TABLE 4

| | Descriptor |
|---|---|
| vps_extension( ) { | |
| ... | |
| rep_format_idx_present_flag | u(1) |
| if( rep_format_idx_present_flag ) | |
| vps_num_rep_formats_minus1 | u(4) |
| for( i = 0; i <= vps_num_rep_formats_minus1; i++ ) | |
| rep_format( ) | |
| if( rep_format_idx_present_flag ) | |
| for( i = 1; i <= vps_max_layers_minus1; i++ ) | |
| [REMOVED: if( vps_num_rep_formats_minus1 > 0 )] | |
| vps_rep_format_idx[ i ] | u(4) |
| ... | |
| } | |

The modified semantics described above with respect to Table 3 are also applied to the syntax elements included in the portion of the VPS sequence syntax structure shown in Table 4.

In another example, the techniques for signaling of representation format information may be implemented by modifying the VPS syntax table and associated semantics to read as follows in Table 5:

TABLE 5

| | Descriptor |
|---|---|
| vps_extension( ) { | |
| ... | |
| vps_num_rep_formats_minus1 | ue(v) |
| for( i = 0; i <= vps_num_rep_formats_minus1; i++ ) | |
| rep format( ) | |
| if( vps_num_rep_formats_minus1 > 0 ) | |
| rep_format_idx_present_flag | u(1) |
| if( rep_format_idx_present_flag ) | |
| for( i = vps_base_layer_internal_flag ? 1 : 0; i <= | |
| MaxLayersMinus1; i++ ) | |
| vps_rep_format_idx[ i ] | u(v) |
| ... | |
| } | |

The value of vps_num_rep_formats_minus1 plus 1 specifies the number of the following rep_format( ) syntax structures in the VPS. The value of vps_num_rep_formats_minus1 shall be in the range of 0 to 255, inclusive.

The value of rep_format_idx_present_flag equal to 1 specifies that the syntax elements vps_rep_format_idx[i] are present in the VPS. The value of rep_format_idx_present_flag equal to 0 specifies that the syntax elements vps_rep_format_idx[i] are not present in the VPS. When not present, the value of rep_format_idx_present_flag is inferred to be equal to 0.

The value of vps_rep_format_idx[i] specifies the index, into the list of rep_format( ) syntax structures in the VPS, of the rep_format( ) syntax structure that applies to the layer with nuh_layer_id equal to layer_id_in_nuh[i]. When not present, the value of vps_rep_format_idx[i] is inferred to be equal to Min(i, vps_num_rep_formats_minus1). The value of vps_rep_format_idx[i] shall be in the range of 0 to vps_num_rep_formats_minus1, inclusive. The number of bits used for the representation of vps_rep_format_idx[i] is Ceil(Log 2(vps_num_rep_formats_minus1+1)).

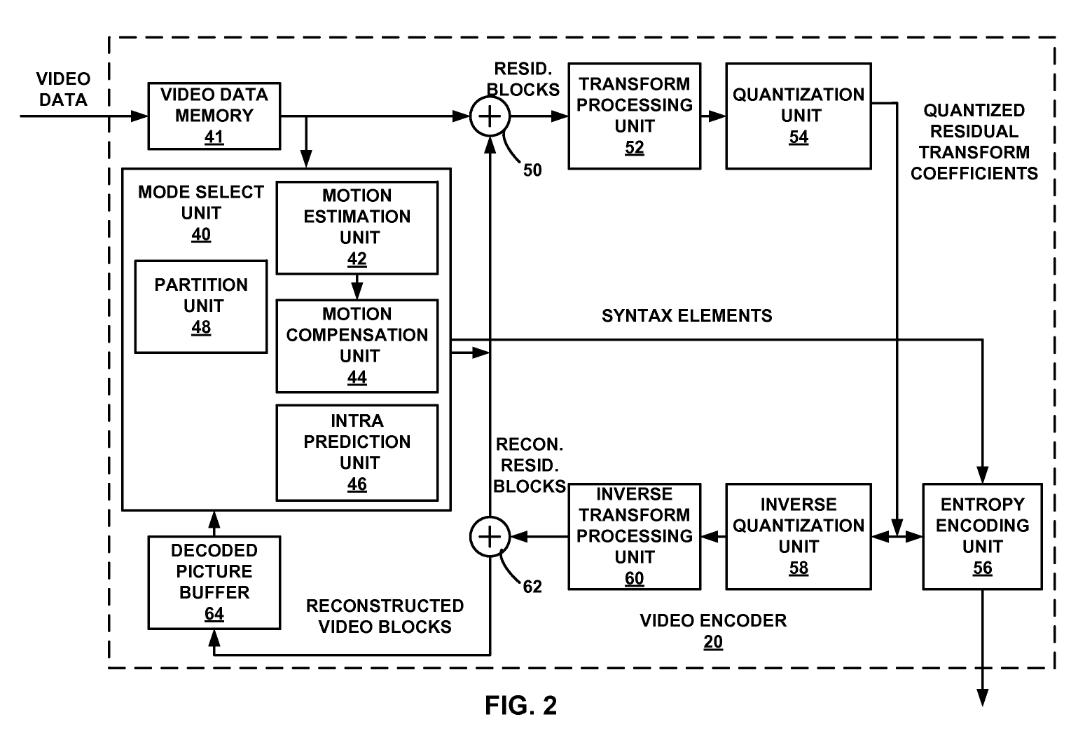

FIG. 2 is a block diagram illustrating an example of video encoder 20 that may implement techniques for indicating representation format information in multi-layer video coding. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 2, video encoder 20 receives a current video block within a video frame to be encoded. In the example of FIG. 2, video encoder 20 includes mode select unit 40, video data memory 41, decoded picture buffer 64, summer 50, transform processing unit 52, quantization unit 54, and entropy encoding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform processing unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

Video data memory 41 may store video data to be encoded by the components of video encoder 20. The video data stored in video data memory 41 may be obtained, for example, from video source 18. Decoded picture buffer 64 may be a reference picture memory that stores reference video data for use in encoding video data by video encoder 20, e.g., in intra- or inter-coding modes. Video data memory 41 and decoded picture buffer 64 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 41 and decoded picture buffer 64 may be provided by the same memory device or separate memory devices. In various examples, video data memory 41 may be on-chip with other components of video encoder 20, or off-chip relative to those components.

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy encoding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference picture (or other coded unit) relative to the current block being coded within the current picture (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in decoded picture buffer 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in decoded picture buffer 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy encoding unit 56. Entropy encoding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization unit 58 and inverse transform processing unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of decoded picture buffer 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in decoded picture buffer 64. The reconstructed video block may be used by motion estimation unit 42 and motion compensation unit 44 as a reference block to inter-code a block in a subsequent video frame.

Video encoder 20 represents an example of a video encoder that may be configured to perform any of the techniques described in this disclosure, alone or in any combination. In one example solution to the first issue of inefficient condition checking in the VPS, described above, video encoder 20 may signal one or more syntax elements associated with representation format information for a video sequence in a bitstream, and signal a condition to check whether a number of representation format syntax structures for the video sequence is greater than one to enter a loop to determine an index value of the representation format syntax structure applied to each layer of the bitstream. The signaled syntax elements may indicate the number of representation format syntax structures for the video sequence and the index values of the representation format syntax structures applied to the layers of the bitstream.

In another example solution to the first issue of inefficient condition checking in the VPS, described above, video encoder 20 may signal one or more syntax elements associated with representation format information for a video sequence in a bitstream, but not signal a condition to check whether a number of representation format syntax structures for the video sequence is greater than one to enter a loop to determine an index value of the representation format syntax structure applied to each layer of the bitstream. In this case, video encoder 20 may implicitly indicate that the index value is equal to zero for a first layer of the bitstream. The signaled syntax elements may indicate the number of representation format syntax structures for the video sequence and the index values of the representation format syntax structures applied to the layers of the bitstream.

In a further example, as a solution to the first issue of inefficient condition checking in the VPS and the fourth issue of the inference rule for representation format syntax structure index values, described above, video encoder 20 may signal one or more representation format syntax structures in a VPS for a video sequence in a multi-layer bitstream, and signal whether syntax elements associated with the representation format syntax structures for the video sequence are encoded in the VPS. Based on the syntax elements not be encoded in the VPS, video encoder 20 may not encode the syntax elements to indicate the index value of one of the representation format syntax structures applied to each layer of the multi-layer bitstream. In this case, video decoder 30 may infer the index value of one of the representation format syntax structures applied to each layer of the multi-layer bitstream based on a number of representation format syntax structures for the video sequence.

In an additional example, as a solution to the second issue of the inference rule for the number of representation format syntax structures and the fourth issue of the inference rule for representation format syntax structure index values, described above, video encoder 20 may signal one or more representation format syntax structures in a VPS for a video sequence in a multi-layer bitstream, signal whether syntax elements associated with representation format syntax structures for the video sequence are encoded in the VPS, and signal a type of multi-layer video coding extension used in the bitstream.

Based on the syntax elements not being coded in the VPS, video encoder 20 may not encode the syntax elements to indicate a number of representation format syntax structures for the video sequence. In this case, video decoder 30 may infer the number of representation format syntax structures based on the type of multi-layer video coding extension used in the bitstream. The type of video coding extension may be a scalable video coding extension, such as SHVC, or a multi-view video coding extension, such as MV-HEVC. Video encoder 20 may also not encode the syntax elements to indicate an index value of one of the representation format syntax structures applied to each layer of the multi-layer bitstream. In this case, video decoder 30 may infer the index value of one of the representation format syntax structures applied to each layer of the multi-layer bitstream based on the inferred number of representation format syntax structures.

In another example, as a solution to the third issue of inference of a number of representation format syntax structures when two types of multi-layer video coding extensions exist in a bitstream, described above, video encoder 20 may signal one or more representation format syntax structures in a VPS for a video sequence in a bitstream, and, based on two or more types of video coding standard extensions being used in the bitstream, always encode syntax elements associated with the representation format syntax structures for the video sequence are encoded in the VPS. The encoded syntax elements explicitly indicate a number of representation format syntax structures for the video sequence. The encoded syntax elements may also explicitly indicate index values of the representation format syntax structures applied to layers of the bitstream.

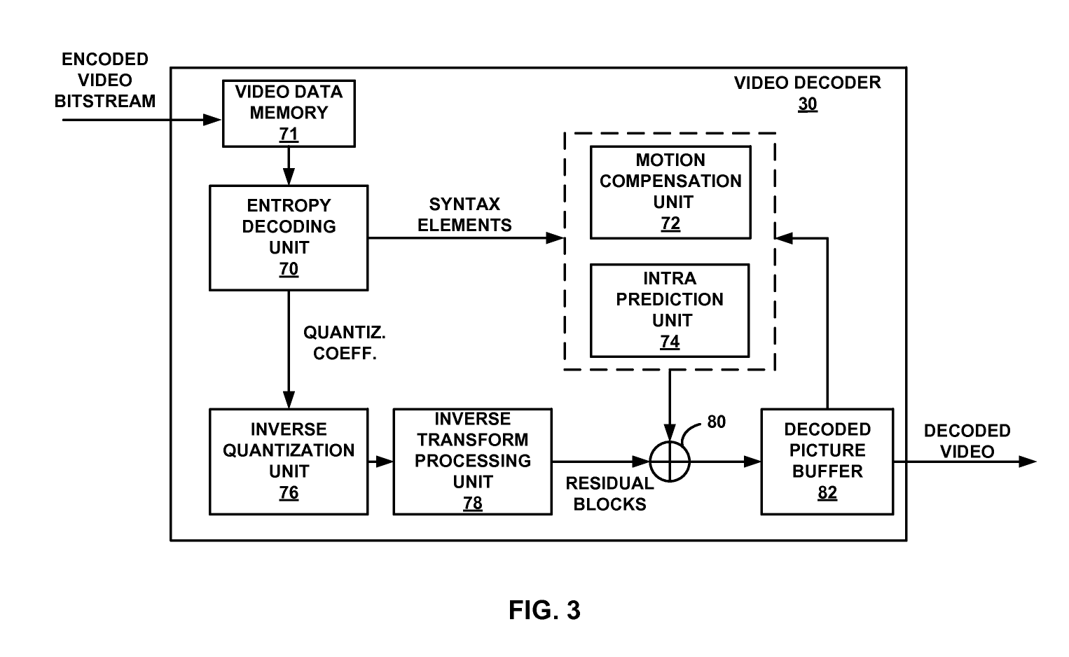

FIG. 3 is a block diagram illustrating an example of video decoder 30 that may implement techniques for determining representation format information in multi-layer video coding. In the example of FIG. 3, video decoder 30 includes an entropy decoding unit 70, a video data memory 71, motion compensation unit 72, intra prediction unit 74, inverse quantization unit 76, inverse transform processing unit 78, decoded picture buffer 82 and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70, while intra-prediction unit 74 may generate prediction data based on intra-prediction mode indicators received from entropy decoding unit 70.

Video data memory 71 may store video data, such as an encoded video bitstream, to be decoded by the components of video decoder 30. The video data stored in video data memory 71 may be obtained, for example, from computer-readable medium 16, e.g., from a local video source, such as a camera, via wired or wireless network communication of video data, or by accessing physical data storage media. Video data memory 71 may form a coded picture buffer (CPB) that stores encoded video data from an encoded video bitstream. Decoded picture buffer 82 may be a reference picture memory that stores reference video data for use in decoding video data by video decoder 30, e.g., in intra- or inter-coding modes. Video data memory 71 and decoded picture buffer 82 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 71 and decoded picture buffer 82 may be provided by the same memory device or separate memory devices. In various examples, video data memory 71 may be on-chip with other components of video decoder 30, or off-chip relative to those components.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current frame or picture. When the video frame is coded as an inter-coded (i.e., B or P) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference picture lists, List 0 and List 1, using default construction techniques based on reference pictures stored in decoded picture buffer 82.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice or P slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de-quantizes, the quantized transform coefficients provided in the bitstream and decoded by entropy decoding unit 70. The inverse quantization process may include use of a quantization parameter QP_{Y} calculated by video decoder 30 for each video block in the video slice to determine a degree of quantization and, likewise, a degree of inverse quantization that should be applied. Inverse transform processing unit 78 applies an inverse transform, e.g., an inverse DCT, an inverse integer transform, or a conceptually similar inverse transform process, to the transform coefficients in order to produce residual blocks in the pixel domain.

After motion compensation unit 72 generates the predictive block for the current video block based on the motion vectors and other syntax elements, video decoder 30 forms a decoded video block by summing the residual blocks from inverse transform processing unit 78 with the corresponding predictive blocks generated by motion compensation unit 72. Summer 80 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in decoded picture buffer 82, which stores reference pictures used for subsequent motion compensation. Decoded picture buffer 82 also stores decoded video for later presentation on a display device, such as display device 32 of FIG. 1.

Video decoder 30 may be configured to perform any or all of the techniques described in this disclosure, alone or in any combination. In one example solution to the first issue of inefficient condition checking in the VPS, described above, video decoder 30 may receive one or more syntax elements associated with representation format information for a video sequence in a bitstream, and check whether a number of representation format syntax structures for the video sequence is greater than one as a condition to enter a loop to determine an index value of the representation format syntax structure applied to each layer of the bitstream. The received syntax elements may indicate the number of representation format syntax structures for the video sequence and the index values of the representation format syntax structures applied to the layers of the bitstream.

In another example solution to the first issue of inefficient condition checking in the VPS, described above, video decoder 30 may receive one or more syntax elements associated with representation format information for a video sequence in a bitstream, and, without checking whether a number of representation format syntax structures for the video sequence is greater than one, enter a loop to determine an index value of the representation format syntax structure applied to each layer of the bitstream. In this case, video decoder 30 may infer that the index value of the representation format syntax structure applied to a first layer of the bitstream is equal to zero. The received syntax elements may indicate the number of representation format syntax structures for the video sequence and the index values of the representation format syntax structures applied to the layers of the bitstream.

In a further example, as a solution to the first issue of inefficient condition checking in the VPS and the fourth issue of the inference rule for representation format syntax structure index values, described above, video decoder 30 may receive a VPS for a video sequence in a multi-layer bitstream including one or more representation format syntax structures, determine whether syntax elements associated with the representation format syntax structures for the video sequence are present in the VPS, and, based on the syntax elements being not present in the VPS, infer an index value of one of the representation format syntax structures applied to each layer of the multi-layer bitstream based on a number of representation format syntax structures for the video sequence.

In an additional example, as a solution to the second issue of the inference rule for the number of representation format syntax structures and the fourth issue of the inference rule for representation format syntax structure index values, described above, video decoder 30 may receive a VPS for a video sequence in a bitstream including one or more representation format syntax structures, determine whether syntax elements associated with the representation format syntax structures for the video sequence are present in the VPS, and infer a number of representation format syntax structures for the video sequence based on a type of multi-layer video coding extension used in the bitstream. The type of multi-layer video coding extension may be a scalable video coding extension, such as SHVC, or a multi-view video coding extension, such as MV-HEVC. Video decoder 30 may also infer an index value of one of the representation format syntax structures applied to each layer of the multi-layer bitstream based on the inferred number of representation format syntax structures.

In another example, as a solution to the third issue of inference of a number of representation format syntax structures when two types of extensions exist in a bitstream, described above, video decoder 30 may receive a VPS for a video sequence in a multi-layer bitstream including one or more representation format syntax structures, and, based on two or more types of multi-layer video coding extensions being used in the bitstream, decode syntax elements associated with the representation format syntax structures for the video sequence included in the VPS. In this case, the decoded syntax elements explicitly indicate a number of representation format syntax structures for the video sequence. The decoded syntax elements may further explicitly indicate index values of the representation format syntax structures applied to layers of the bitstream.

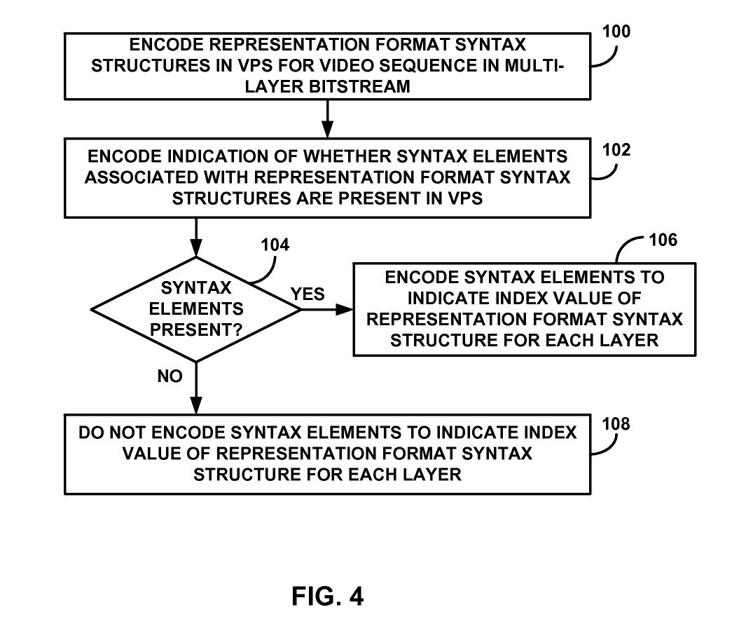

FIG. 4 is a flowchart illustrating an example operation of indicating mapping of representation formats to layers in a multi-layer bitstream. The example operation is described with respect to entropy encoding unit 56 of video encoder 20 from FIG. 2. In some cases, entropy encoding unit 56 may explicitly signal the mapping in a VPS for a video sequence to identify which representation format is applied to which layer in the bitstream. If syntax elements indicating the mapping are not encoded in the VPS, the absence of the syntax elements may prompt video decoder 30 to infer the mapping of the representation formats to the different layers according to a predefined inference rule.

Entropy encoding unit 56 encodes one or more representation format syntax structures in a VPS for a video sequence in a multi-layer bitstream (100). Entropy encoding unit 56 encodes an indication of whether syntax elements associated with the representation format syntax structures are present in the VPS (102). For example, the encoded indication may comprise a flag included in the VPS that indicates whether or not index values of the representation format syntax structures that are mapped to the different layers in the multi-layer bitstream are explicitly signaled in the VPS.

If the syntax elements are present in the VPS (YES branch of 104), entropy encoding unit 56 encodes the syntax elements to explicitly indicate an index value of one of the representation format syntax structures applied to each layer of the multi-layer bitstream (106). In this case, entropy encoding unit 56 may enter a loop to encode the syntax elements that indicate the index value of the one of the representation format syntax structures applied to each layer of the multi-layer bitstream without signaling a condition to check whether a number of representation format syntax structures for the video sequence is greater than one.

If the syntax elements are not present in the VPS (NO branch of 104), entropy encoding unit 56 does not encode syntax elements to indicate an index value of one of the representation format syntax structures applied to each layer of the multi-layer bitstream (108). In this case, by the absence of the syntax elements in the VPS, the bitstream encoded by entropy encoding unit 56 may prompt video decoder 30 to infer an index value of one of the representation format syntax structure applied to each layer in the multi-layer bitstream based on a number of the representation format syntax structures for the video sequence.

Conventionally, if syntax elements are not present in the VPS, the absence of the syntax elements prompts a video decoder to infer that a representation format syntax structure with an index value equal to zero is applied to all of the layers in the bitstream according to a predefined, static inference rule. This inference may not always be accurate depending on which type of multi-layer video extension is used in the bitstream, e.g., MV-HEVC and/or SHVC.

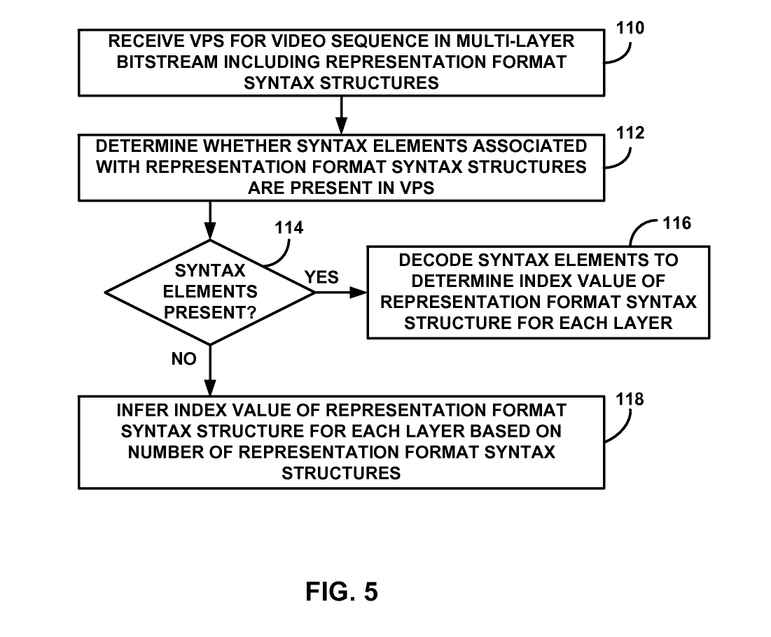

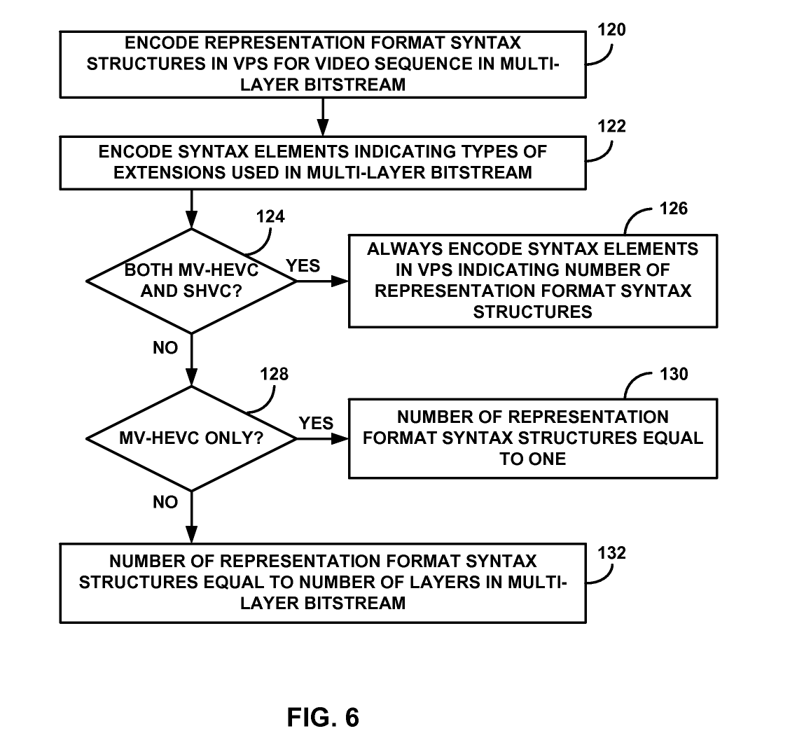

According to the techniques of this disclosure, the absence of the syntax elements may prompt video decoder 30 to infer which of the representation format syntax structures is applied to which of the layers in the bitstream based on the number of representation format syntax structures encoded in the VPS for the video sequence. The mapping inference based on the number of representation format syntax structures is described in more detail below with respect to FIG. 5. The number of representation format syntax structures for the video sequence may be explicitly or implicitly indicated by entropy encoding unit 56, as described in more detail below with respect to FIG. 6.

FIG. 5 is a flowchart illustrating an example operation of determining mapping of representation formats to layers in a multi-layer bitstream. The example operation is described with respect to entropy decoding unit 70 of video decoder 30 from FIG. 3. In some cases, entropy decoding unit 70 may determine the mapping based on syntax elements encoded in a VPS for a video sequence that explicitly indicate which representation format is applied to which layer in the bitstream. If syntax elements indicating the mapping are not encoded in the VPS, entropy decoding unit 70 may infer the mapping of the representation formats to the different layers according to a predefined inference.

Entropy decoding unit 70 receives a VPS for a video sequence in a multi-layer bitstream including one or more representation format syntax structures (110). Entropy decoding unit 70 determines whether syntax elements associated with the representation format syntax structures are present in the VPS (112). For example, entropy decoding unit 70 may decode a flag included in the VPS that indicates whether or not index values of the representation format syntax structures that are mapped to the different layers of the multi-layer bitstream are explicitly signaled in the VPS.

If the syntax elements are present in the VPS (YES branch of 114), entropy decoding unit 70 decodes the syntax elements in the VPS to determine an index value of one of the representation format syntax structures applied to each layer of the multi-layer bitstream (116). If the syntax elements are not present in the VPS (NO branch of 114), entropy decoding unit 70 infers an index value of one of the representation format syntax structure applied to each layer in the multi-layer bitstream based on a number of the representation format syntax structures for the video sequence (118).

In some examples, even if the syntax elements are present in the VPS, the representation format applied to the base layer in the bitstream may not be explicitly indicated in the VPS. In this case, entropy decoding unit 70 may infer that a first representation format syntax structure having an index value equal to zero is applied to the base layer in the bitstream. A base layer included in the bitstream may conform to the HEVC standard. In other examples, a base layer external to the bitstream may conform to a different video coding standard and may be assigned a representation format either explicitly or implicitly.

Conventionally, if syntax elements are not present in the VPS, a video decoder infers that a representation format syntax structure with an index value equal to zero is applied to all of the layers in the bitstream. This inference may be accurate in the case where MV-HEVC is the multi-layer video extension used in the bitstream, but may not be accurate in the case where SHVC is the multi-layer video extension used in the bitstream. In the case of MV-HEVC, the representation format typically does not change from layer to layer in the multi-layer bitstream. On the other hand, in the case of SHVC, the representation format is typically different for each layer of the multi-layer bitstream.

According to the techniques of this disclosure, in the absence of the syntax elements, entropy decoding unit 70 infers which of the representation format syntax structures is applied to which of the layers in the bitstream based on the number of representation format syntax structures included in the VPS for the video sequence. By basing the mapping inference on the number of representation format syntax structures, the inference may be accurate for the type of multi-layer video extension used in the bitstream, e.g., MV-HEVC and/or SHVC.

For example, when one single representation format syntax structure is included in the VPS for the video sequence, which may be the case in a MV-HEVC bitstream, entropy decoding unit 70 may infer that the single representation format syntax structure having an index value equal to zero is applied to all of the layers in the bitstream. In another example, when the number of representation format syntax structures for the video sequence is equal to a number of layers in the multi-layer bitstream, which may be the case in a SHVC bitstream, entropy decoding unit 70 may infer a one-to-one mapping in which each of the representation format syntax structures having an index value equal to one of the layer numbers is applied to the respective one of the layers in the bitstream.

In yet another example, entropy decoding unit 70 may infer that the one of the representation format syntax structures applied to each of the layers in the bitstream has an index value equal to a minimum of either the layer number of the respective layer or the total number of representation format syntax structures for the video sequence minus one. In the case of a MV-HEVC bitstream that includes one single representation format syntax structure and multiple layers, entropy decoding unit 70 may infer that the representation format syntax structure applied to each of the layers has an index value equal to zero, which is equal to the minimum of the respective layer number or zero (i.e., the number of representation syntax structures minus one). For example, when the multi-layer bitstream includes five layers (i=0 . . . 4) and one representative format (index value=0), entropy decoding unit 70 may infer the mapping as follows: index value 0 for layer 0, index value 0 for layer 1, index value 0 for layer 2, index value 0 for layer 3, and index value 0 for layer 4.

In the case of a SHVC bitstream that includes a number of representation format syntax structures equal to a number of layers in the bitstream, entropy decoding unit 70 may infer that the one of the representation format syntax structures applied to each of layers has an index value equal to the respective layer number, which is equal to the minimum of the respective layer number or the total number of layers minus one. For example, when the multi-layer bitstream includes five layers (i=0 . . . 4) and five representative formats (index value=0 . . . 4), entropy decoding unit 70 may infer the mapping as follows: index value 0 for layer 0, index value 1 for layer 1, index value 2 for layer 2, index value 3 for layer 3, and index value 4 for layer 4.

In addition, in the case of a multi-layer bitstream that includes more than one representation format syntax structure, entropy decoding unit 70 may infer that the one of the representation format syntax structures applied to each of layers has an index value equal to the respective layer number up to the number of representative format syntax structures minus one. As one example, when the multi-layer bitstream includes five layers (i=0 . . . 4) and three representative formats (index value=0 . . . 2), entropy decoding unit 70 may infer the mapping as follows: index value 0 for layer 0, index value 1 for layer 1, index value 2 for layer 2, index value 2 for layer 3, and index value 2 for layer 4.

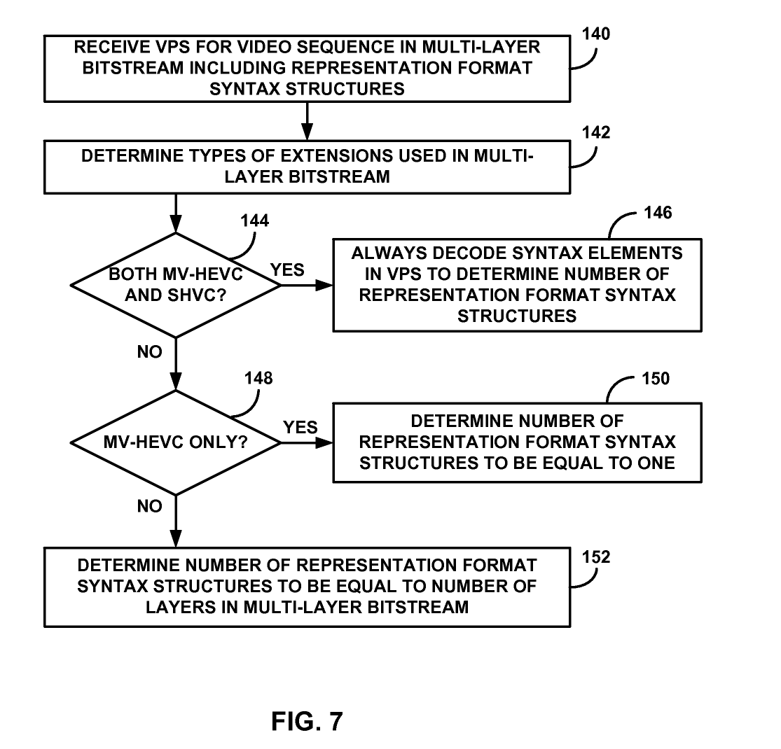

The number of representation format syntax structures for the video sequence may be determined based on syntax elements or a predefined inference, as described in more detail below with respect to FIG. 7.

FIG. 6 is a flowchart illustrating an example operation of indicating a number of representation format syntax structures included in a VPS for a video sequence in a multi-layer bitstream. The example operation is described with respect to entropy encoding unit 56 of video encoder 20 from FIG. 2.

Entropy encoding unit 56 encodes one or more representation format syntax structures in a VPS for a video sequence in a multi-layer bitstream (120). Entropy encoding unit 56 also encodes one or more syntax elements indicating types of multi-layer video coding extensions used in the multi-layer bitstream (122). For example, entropy encoding unit 56 may encode syntax elements referred as scalability_mask[i] or scalability_mask_flag[i] in which a scalability mask index i indicates the type of multi-layer coding extensions used in the multi-layer bitstream. In some cases, a scalability mask index equal to 1 may indicate a multi-view video coding extension, such as MV-HEVC, and a scalability mask index equal to 2 may indicate a spatial scalability video coding extension, such as SHVC.

If both the MV-HEVC and the SHVC extensions are used in the multi-layer bitstream (YES branch of 124), entropy encoding unit 56 always encodes one or more syntax elements in the VPS to explicitly indicate the number of representation format syntax structures for the video sequence (126). In this case, video decoder 30 does not infer the number of representation format syntax structures based on a predefined inference rule. According to the techniques described in this disclosure, the type of multi-layer video coding extension included in the multi-layer bitstream may be used by video decoder 30 to infer the number of the representation format syntax structures for the video sequence. When both the MV-HEVC and the SHVC extensions are used in the bitstream, however, it may be difficult or impossible for video decoder 30 to infer an accurate number of representation format syntax structures for both types of extensions.

If only the MV-HEVC extension in used in the multi-layer bitstream (NO branch of 124 and YES branch of 128), the number of the representation format syntax structures for the video sequence may be equal to one for the MV-HEVC bitstream (130). In some cases, entropy encoding unit 56 may encode a syntax element in the VPS to indicate that there is one representation format syntax structure for the video sequence. In other cases, entropy encoding unit 56 may not encode a syntax element in the VPS to indicate the number of representation format syntax structures. Video decoder 30 may then infer the number of representation format syntax structures as equal to one based on only the MV-HEVC extension being used in the multi-layer bitstream.

If only the SHVC extension in used in the multi-layer bitstream (NO branch of 124 and NO branch of 128), the number of the representation format syntax structures for the video sequence may be equal to a total number of layers included in the SHVC bitstream (132). In some cases, entropy encoding unit 56 may encode a syntax element in the VPS to indicate that the number of representation format syntax structure for the video sequence is equal to the total number of layers. In other cases, entropy encoding unit 56 may not encode a syntax element in the VPS to indicate the number of representation format syntax structures. Video decoder 30 may then infer the number of representation format syntax structures as equal to the total number of layers based on only the SHVC extension being used in the multi-layer bitstream.

FIG. 7 is a flowchart illustrating an example operation of determining a number of representation format syntax structures included in a VPS for a video sequence in a multi-layer bitstream. The example operation is described with respect to entropy decoding unit 70 of video decoder 30 from FIG. 3.

Entropy decoding unit 70 receives a VPS for a video sequence in a multi-layer bitstream including one or more representation format syntax structures (140). Entropy decoding unit 70 also determines types of multi-layer video coding extensions used in the multi-layer bitstream (142). For example, entropy decoding unit 70 may decode syntax elements referred as scalability_mask[i] or scalability_mask_flag[i] in which a scalability mask index i indicates the type of multi-layer coding extensions used in the multi-layer bitstream. As described above, a scalability mask index equal to 1 may indicate a multi-view video coding extension, such as MV-HEVC, and a scalability mask index equal to 2 may indicate a spatial scalability video coding extension, such as SHVC.

If both the MV-HEVC and the SHVC extensions are used in the multi-layer bitstream (YES branch of 144), entropy decoding unit 70 always decodes one or more syntax elements included in the VPS to determine the number of representation format syntax structures for the video sequence (146). In this case, the number of representation format syntax structures should not be inferred based on the type of multi-layer video coding extension used in the multi-layer bitstream. When both the MV-HEVC and the SHVC extensions are used in the bitstream, it may be difficult or impossible to infer an accurate number of representation format syntax structures for both types of extensions.

If only the MV-HEVC extension in used in the multi-layer bitstream (NO branch of 144 and YES branch of 148), entropy decoding unit 70 may determine the number of the representation format syntax structures for the video sequence to be equal to one for the MV-HEVC bitstream (150). In some cases, entropy decoding unit 70 may decode a syntax element in the VPS to determine that there is one representation format syntax structure for the video sequence. In other cases, entropy decoding unit 70 may infer the number of representation format syntax structures based on only the MV-HEVC extension being used in the multi-layer bitstream. In the case of MV-HEVC, the representation format typically does not change from layer to layer in the multi-layer bitstream. It is accurate, therefore, for entropy decoding unit 70 to infer that the MV-HEVC bitstream includes one representation format syntax structure for the video sequence, such that the single representation format syntax structure is applied to all of the layers in the multi-layer bitstream.

If only the SHVC extension in used in the multi-layer bitstream (NO branch of 144 and NO branch of 148), entropy decoding unit 70 may determine the number of the representation format syntax structures for the video sequence to be equal to a total number of layers included in the SHVC bitstream (152). In some cases, entropy decoding unit 70 may decode a syntax element in the VPS to determine that the number of representation format syntax structures for the video sequence is equal to the total number of layers. In other cases, entropy decoding unit 70 may infer the number of representation format syntax structures based on only the SHVC extension being used in the multi-layer bitstream. In the case of SHVC, the representation format is typically different for each layer of the multi-layer bitstream. It is accurate, therefore, for entropy decoding unit 70 to infer that the SHVC bitstream includes a number of the representation format syntax structures equal to the total number of layers for the video sequence, such that a different one of the representation format syntax structures is applied to each of the layers in the multi-layer bitstream.

Certain aspects of this disclosure have been described with respect to the developing HEVC standard for purposes of illustration. However, the techniques described in this disclosure may be useful for other video coding processes, including other standard or proprietary video coding processes not yet developed. A video coder, as described in this disclosure, may refer to a video encoder or a video decoder. Similarly, a video coding unit may refer to a video encoder or a video decoder. Likewise, video coding may refer to video encoding or video decoding, as applicable.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
receiving a video parameter set (VPS) for a video sequence in a multi-layer bitstream, the VPS including one or more representation format syntax structures for the video sequence;
determining whether syntax elements associated with the one or more representation format syntax structures for the video sequence are present in the VPS; and
based on the syntax elements not being present in the VPS, inferring an index value of one of the one or more representation format syntax structures applied to each layer of the multi-layer bitstream based on a number of the one or more representation format syntax structures for the video sequence.

2. The method of claim 1, wherein each of the one or more representation format syntax structures indicates representation format information for the video sequence, wherein the representation format information includes one or more of spatial resolution, bit depth, color format, or conformance window offset information for the video sequence.

3. The method of claim 1, wherein the number of the one or more representation format syntax structures for the video sequence is equal to one, and wherein inferring the index value comprises inferring the index value of the one representation format syntax structure applied to each layer of the multi-layer bitstream to be equal to zero.

4. The method of claim 1, wherein the number of the one or more representation format syntax structures for the video sequence is equal to a total number of layers in the multi-layer bitstream, and wherein inferring the index value comprises inferring the index value of the one of the representation format syntax structures applied to each layer of the multi-layer bitstream to be equal to a layer number of the respective layer.

5. The method of claim 1, wherein the number of the one or more representation format syntax structures for the video sequence is greater than one, and wherein inferring the index value comprises inferring the index value of the one of the representation format syntax structures applied to each layer of the multi-layer bitstream to be equal to a layer number of the respective layer up to the number of representation format syntax structures for the video sequence.

6. The method of claim 1, wherein determining whether the syntax elements associated with the one or more representation format syntax structures are present in the VPS comprises decoding a flag included in the VPS that indicates whether the index values of the one or more representation format syntax structures that are applied to each of the layers of the multi-layer bitstream are explicitly signaled in the VPS.

7. The method of claim 1, further comprising, based on the syntax elements associated with the one or more representation format syntax structures being present in the VPS, decoding the syntax elements to determine the index value of the one of the one or more representation format syntax structures applied to each layer of the multi-layer bitstream.

8. The method of claim 7, wherein decoding the syntax elements associated with the one or more representation format syntax structures comprises entering a loop to determine the index value of the one of the one or more representation format syntax structures applied to each layer of the multi-layer bitstream without checking whether the number of representation format syntax structures for the video sequence is greater than one.

9. The method of claim 1, further comprising decoding one or more syntax elements included in the VPS to determine the number of the one or more representation format syntax structures for the video sequence.

10. The method of claim 1, further comprising inferring the number of the one or more representation format syntax structures for the video sequence based on a type of multi-layer video coding extension used in the multi-layer bitstream, wherein the type of multi-layer video coding extension may be one of a scalable video coding extension or a multi-view video coding extension.

11. The method of claim 10, wherein the type of multi-layer video coding extension used in the multi-layer bitstream is the scalable video coding extension, and wherein inferring the number of the one or more representation format syntax structures comprises inferring the number of the one or more representation format syntax structures to be equal to a total number of layers in the multi-layer bitstream.

12. The method of claim 10, wherein the type of multi-layer video coding extension used in the multi-layer bitstream is the multi-view video coding extension, and wherein inferring the number of the one or more representation format syntax structures comprises inferring the number of the one or more representation format syntax structures to be equal to one.

13. The method of claim 1, further comprising, based on both a scalable video coding extension and a multi-view video coding extension being used in the multi-layer bitstream, always decoding one or more syntax elements to determine the number of the one or more representation format syntax structures for the video sequence.

14. A video decoding device comprising:
a memory configured to store video data; and
one or more processors in communication with the memory and configured to:
receive a video parameter set (VPS) for a video sequence in a multi-layer bitstream, the VPS including one or more representation format syntax structures for the video sequence;
determine whether syntax elements associated with the one or more representation format syntax structures for the video sequence are present in the VPS; and
based on the syntax elements not being present in the VPS, infer an index value of one of the one or more representation format syntax structures applied to each layer of the multi-layer bitstream based on a number of the one or more representation format syntax structures for the video sequence.

15. The device of claim 14, wherein each of the one or more representation format syntax structures indicates representation format information for the video sequence, wherein the representation format information includes one or more of spatial resolution, bit depth, color format, or conformance window offset information for the video sequence.

16. The device of claim 14, wherein the number of the one or more representation format syntax structures for the video sequence is equal to one, and wherein the processors infer the index value of the one representation format syntax structure applied to each layer of the multi-layer bitstream to be equal to zero.

17. The device of claim 14, wherein the number of the one or more representation format syntax structures for the video sequence is equal to a total number of layers in the multi-layer bitstream, and wherein the processors infer the index value of the one of the representation format syntax structures applied to each layer of the multi-layer bitstream to be equal to a layer number of the respective layer.

18. The device of claim 14, wherein the number of the one or more representation format syntax structures for the video sequence is greater than one, and wherein the processors infer the index value of the one of the representation format syntax structures applied to each layer of the multi-layer bitstream to be equal to a layer number of the respective layer up to the number of representation format syntax structures for the video sequence.

19. The device of claim 14, wherein the processors decode a flag included in the VPS that indicates whether the index values of the one or more representation format syntax structures that are applied to each of the layers of the multi-layer bitstream are explicitly signaled in the VPS.

20. The device of claim 14, wherein, based on the syntax elements associated with the one or more representation format syntax structures being present in the VPS, the processors are configured to decode the syntax elements to determine the index value of the one of the one or more representation format syntax structures applied to each layer of the multi-layer bitstream.

21. The device of claim 20, wherein the processors enter a loop to determine the index value of the one of the one or more representation format syntax structures applied to each layer of the multi-layer bitstream without checking whether the number of representation format syntax structures for the video sequence is greater than one.

22. The device of claim 14, wherein the processors are configured to decode one or more syntax elements included in the VPS to determine the number of the one or more representation format syntax structures for the video sequence.

23. The device of claim 14, wherein the processors are configured to infer the number of the one or more representation format syntax structures for the video sequence based on a type of multi-layer video coding extension used in the multi-layer bitstream, wherein the type of multi-layer video coding extension may be one of a scalable video coding extension or a multi-view video coding extension.

24. The device of claim 23, wherein the type of multi-layer video coding extension used in the multi-layer bitstream is the scalable video coding extension, and wherein the processors infer the number of the one or more representation format syntax structures to be equal to a total number of layers in the multi-layer bitstream.

25. The device of claim 23, wherein the type of multi-layer video coding extension used in the multi-layer bitstream is the multi-view video coding extension, and wherein the processors infer the number of the one or more representation format syntax structures to be equal to one.

26. The device of claim 14, based on both a scalable video coding extension and a multi-view video coding extension being used in the multi-layer bitstream, the processors are configured to always decode one or more syntax elements to determine the number of the one or more representation format syntax structures for the video sequence.

27. A video decoding device comprising:
means for receiving a video parameter set (VPS) for a video sequence in a multi-layer bitstream, the VPS including one or more representation format syntax structures for the video sequence;
means for determining whether syntax elements associated with the one or more representation format syntax structures for the video sequence are present in the VPS; and
based on the syntax elements not being present in the VPS, means for inferring an index value of one of the one or more representation format syntax structures applied to each layer of the multi-layer bitstream based on a number of the one or more representation format syntax structures for the video sequence.

28. The device of claim 27, wherein the number of the one or more representation format syntax structures for the video sequence is equal to one, and wherein the means for inferring the index value comprise means for inferring the index value of the one representation format syntax structure applied to each layer of the multi-layer bitstream to be equal to zero.

29. The device of claim 27, wherein the number of the one or more representation format syntax structures for the video sequence is equal to a total number of layers in the multi-layer bitstream, and wherein the means for inferring the index value comprise means for inferring the index value of the one of the representation format syntax structures applied to each layer of the multi-layer bitstream to be equal to a layer number of the respective layer.

30. A computer-readable medium having stored thereon instructions for decoding video data that, when executed, cause one or more processors to:
receive a video parameter set (VPS) for a video sequence in a multi-layer bitstream, the VPS including one or more representation format syntax structures for the video sequence;
determine whether syntax elements associated with the one or more representation format syntax structures for the video sequence are present in the VPS; and
based on the syntax elements not being present in the VPS, infer an index value of one of the one or more representation format syntax structures applied to each layer of the multi-layer bitstream based on a number of the one or more representation format syntax structures for the video sequence.
